(19) United States
(12) Patent Application Publication
(10) Pub. No.: US 2015/0178793 A1
(43) Pub. Date: Jun. 25, 2015

(54) SYSTEM AND METHOD FOR MANAGING ONLINE ADVERTISING

(71) Applicant: VNG Corporation, Ho Chi Minh City (VN)

(72) Inventors: Nguyen Cong CHINH, Ho Chi Minh City (VN); Vuong Quang KHAI, Ho Chi Minh City (VN)

(21) Appl. No.: 14/577,589

(22) Filed: Dec. 19, 2014

(30) Foreign Application Priority Data
Dec. 23, 2013 (VN) 1-2013-04057

(51) Int. Cl. G06Q 30/02

(52) U.S. Cl. CPC G06Q 30/0277; G06Q 30/0201

(57) ABSTRACT

The present invention provides an online advertising managing system (1) comprises: user personal computers (2), information sources (3) about market sentiment, a central managing unit (4) that includes an information collecting unit (41), analyzing unit (42), a controlling module (43), a displaying unit (44), an information storing module (45); and a central server (5) and an online advertising managing method using the system comprises the steps of: setting keywords, conditions, requests for advertising campaigns; exploiting information; analyzing a market sentiment; controlling the advertising campaign; storing the collected information.

### FIELD OF THE INVENTION

The present invention relates to systems and methods for managing online advertising, more specifically to systems for managing online advertising campaigns based on market sentiments of one or more keywords about brands or goods from an initial database including information about these keywords.

### BACKGROUND OF THE FIELD OF INVENTION

Nowadays, with the development of the internet network, consumers can receive information from one or various communication media, simultaneously, can feedback or express their opinions to this information. Besides, online advertising activities are also rapidly developing and the information exploiting from online information channels for serving the online advertising has been being focused on research and improvement.

US20130085803 provides a system for analyzing the strength or weakness of a brand reflected on online and offline media. The system automatically collects data relating to a particular brand from various communication channels, these channels can serve as input data of the communication channels for advertising campaigns. The system generates a score for each communication channel by which a comparison of the input data of each brand in the same communication condition is performed. An aggregate score is calculated from the scores of each communication media. The score generating and score analyzing reflect a strength and weakness of a brand.

However, in this system, the data analyzing unit is separate from the advertising campaign running system, this causes the difficulty for users as well as for advertising businesses in controlling advertising campaigns as well as in operating advertising system.

US20130151332 provides an advertisement displaying system that allows performing advertising campaigns to a target group specified by initial criteria. The system evaluates advertisement results based on many evaluating criteria in each of various segments of the target group through feedbacks of consumer to the initial displays. Based on the evaluating results for each segment, the displaying system suggests to the advertiser modifications, adjustments for the advertising campaign. The adjustments can include narrowing the initial targeting criteria to direct at least a particular segment as the target group, performing a new advertising content for a segment having a low feedback and adjusting the price for the displaying, putting advertisement in the campaign.

However, in the above solution, businesses must try to run some advertising campaigns in a certain scale, then get the initial information for analysis. Besides, the solution just build a system for analyzing market sentiment, then introduce a simple result or just introduces some suggestions to businesses. Then, the advertising campaign implementing businesses still have to make comparisons based on the analyzing results to introduce a specific decision for each advertising campaign.

Moreover, because the input data of this technical solution are targeting criteria to be achieved in the advertising campaign, thus for targets done fastly or done before implementing the campaign, the above solution cannot feedback immediately to pause or cannot implement the advertising campaign, but still have to run the unnecessary and ineffective campaign until the end of the campaign. Therefore, this causes a waste of time, effort and money for businesses.

From the present existing technical problems, after investing on time, effort, the inventor provides systems and methods for managing online advertising campaigns that overcome effectively the limitations of the present techniques.

### SUMMARY OF THE INVENTION

In order to overcome the above limitations, according to an aspect, the present invention provides an online advertising managing system that comprises:
user personal computers connected to information sources and the remaining parts of the system;
information sources about market sentiment;
a central managing unit that includes a first module serving as an information collecting unit; a second module serving as market sentiment analyzing unit; a third module for controlling advertising campaign; a fourth module serving as a displaying unit of the system; a fifth module for storing information; and
a central server connected to the personal computers and the central managing unit.

The invention also provides an online advertising campaign managing method using the above-mentioned system, the method comprises the steps of:
setting, in which keywords about brands or goods are determined, conditions, requests for an advertising campaign are set by both the fourth module and the third module of the system of the invention;
exploiting information, the first module collects information with the conditions set in the above-mentioned step;
analyzing market sentiment, the second module sorts the information collected from the above-mentioned step into groups, subgroups and analyzes the market sentiment in order to determine the trends and levels of the sentiment from the collected and sorted data;
controlling the advertising campaign, the third module receives the analyzed results from the second module, compares the results with predetermined conditions and designates actions corresponding to the conditions set in the first step;
storing the collected information, the designation of the performing actions, results of the advertising campaigns on the system in order to monitor and re-use in the next times.

The advantages of the invention:

The system of the invention supports businesses to control advertising campaigns easily and minimize unnecessary arising cost.

The user can set conditions when starting a campaign, basing on the status of the set criteria in the real time, the system will process, implement and adjust the campaign automatically. It thereby brings a high effect, saves the human physical strength, cost for the campaign.

### BRIEF DESCRIPTION OF THE DRAWINGS

The technical objects and the advantages of the technical solution will be clearly understood by persons having ordinary skill in the art after viewing the detailed description with reference to the accompanying drawings, in which:

FIG. 1 is a diagram that illustrates an online advertising managing system according to the present invention;

FIG. 2 is a flow chart that illustrates steps performing an online advertising managing method according to the present invention;

FIG. 3 is a flow chart that illustrates flows of information, data in the operating process of the online advertising managing system and method according to the present invention;

FIG. 4 illustrates an example of the user interface of the online advertising managing system according to the present invention;

FIG. 5A-E illustrate steps performing the online advertising managing method according to the present invention through a fourth module.

### DETAILED DESCRIPTION OF EMBODIMENTS OF THE INVENTION

The invention will be described more details in the following detailed description of embodiments. It should be noted that the preferred embodiments of the invention described below are intended only for the purposes of illustrating and interpreting the invention, but do not limit embodiments of the solution and the invention is not limited in this description.

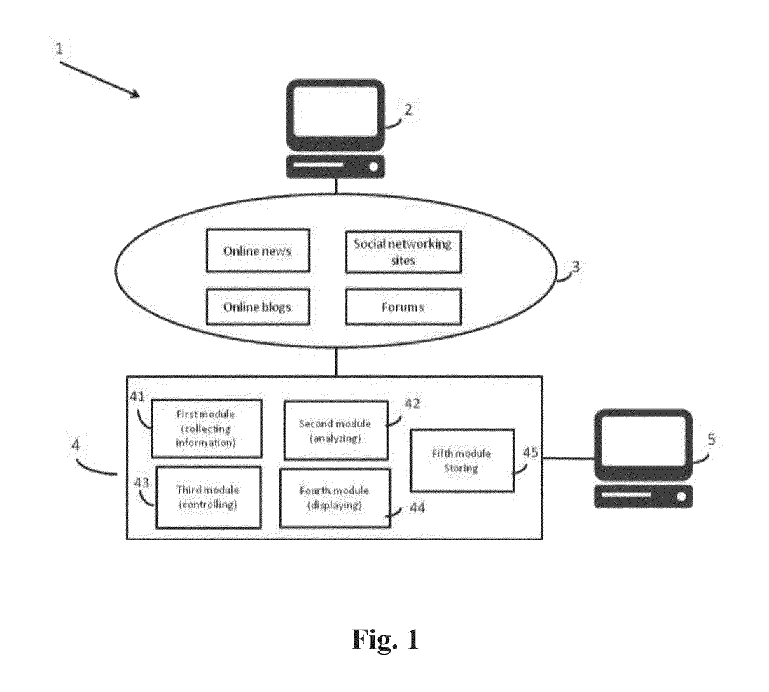

With reference to FIG. 1, that is a diagram illustrating an online advertising managing system 1 according to the present invention, the system comprises user personal computers 2 connected to information sources 3 about market sentiment through a computer network to a central managing unit 4, this unit operates as a central server and is connected to an operating computer 5. Accordingly, the user personal computers 2 and the operating computer 5 play the role of output/input processing devices of the system and are connected to the computer network 3 and the central server. Preferably, the user personal computers 2, the central server and the operating computer 5 are connected to each other through the internet network in order to constitute an operating network.

The users who work on the personal computers 2 can access and collect information from the central server directly or through the computer network. In the meantime, a manager can access the central managing unit 4 through the operating computer 5 connected to the central server. Preferably, the information sources inputted into and used for the system are selected from a group consisting of information from online news websites, online blogs, online forums, online social networking sites or the combination thereof. More specifically, the online blogs are selected from a group consisting of wordpress, blogpot, ect., or the combination thereof; the social networking sites are selected from a group consisting of Facebook, twitter, linkedin, pinterest, myspace, google+, ect., or the combination thereof.

As illustrated in FIG. 1, the central managing unit is formed from five modules. More specifically, a first module 41 serves as an information collecting unit, which operates as a detecting unit of the search engines for collecting a large amount of necessary information. Preferably, the information from various sources, after collected by the first module, will be pre-processed by techniques selected from a group consisting of language filter, text synchronous coding, web main content identifying or the combination thereof. The second module 42 serves as a market sentiment analyzing unit. For the analysis purpose, this module applies nature language processing techniques such as word analyzing, text section marking, exist name identifying, specifically in the online news, a brand name or a good name, have been being run for some certain advertising campaigns. The other techniques, such as syntax analyzing, discussion nature identifying, and opinion collecting, are also applied to each article in order to evaluate opinions of the authors, consumers about interesting brands or goods. The third module 43 plays the role of controlling advertising campaigns. This module uses the results collected from the market sentiment analyzing unit to evaluate feedbacks of the market in each subgroup. More specifically, the third module 43 determines that the market sentiment in each subgroup is positive or negative to each particular brand or good in the advertising campaigns. Preferably, the information sources are divided into subgroups based on the information content such as: category, sources, etc., or based on a consumer group such as: sex, age, living place, etc. Therefore, the third module can easily determine a target suitable for each advertising campaign. The fourth module 44 serves as a displaying unit. This module allows displaying each step of the method, allows the user to operate, initiate an advertising campaign, set conditions and monitor results of the campaigns. The aggregate of the market sentiments in each subgroup about a brand or a good is displayed in the form of data tables, diagrams, detecting ticket. Thereby this module allows identifying the target exactly for each advertising campaign. The fifth module 45 allows storing information, accordingly the collected information, the designation of the performing actions, results of the advertising campaigns, etc., are stored to monitor and re-use in next times.

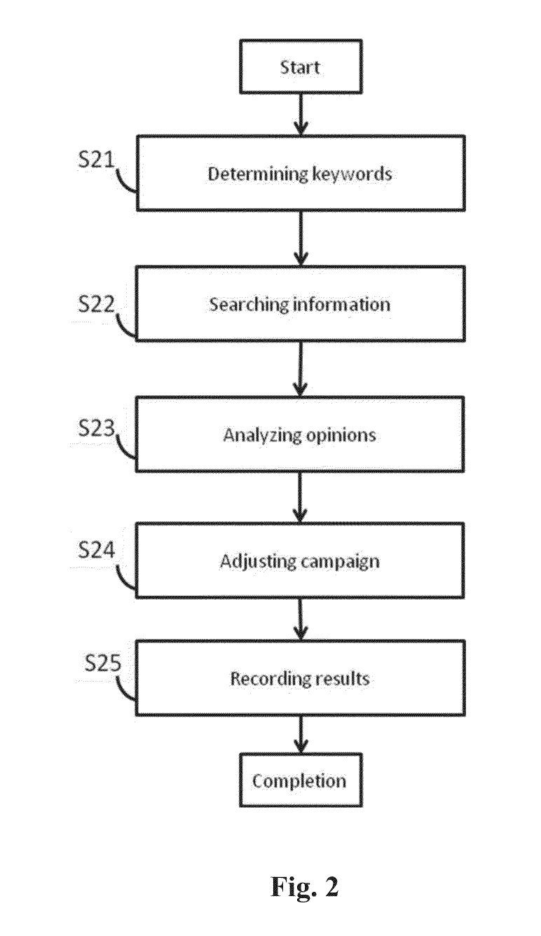

With reference to FIG. 2, that illustrates steps of an online advertising managing method using the system in accordance with an embodiment of the present invention, in which the steps of the method are performed by various parts of the online advertising managing system 1. The method comprises the following steps:

The setting step S21, in which through both the fourth module 44 and the third module 43, keywords are determined, operations, requests for the advertising campaigns are set. More specifically, through the controlling module and the displaying module of the system, the user determines one or more keywords about an interesting brand or good, sets conditions about information sources, fields of information to be exploited, object of the requests to be obtained, groups of consumer object to be approached (sex, age, occupation, living place).

The information exploiting step S22, in which through the fourth module 44, the user can control the first module 41 to collect information from the sources determined in the above-mentioned step relating to keywords about the interesting brand or good that will be analyzed. Preferably, the first module 41 periodically operates in a determined time period. Preferably, the first module periodically collects information in a time period of 5 to 10 minutes.

The market sentiment analyzing step S23, the second module 42 sorts collected information into the subgroups. Preferably, the groups, subgroups are pre-selected by the user, at the building of the advertising campaigns or in the setting step S21. Simultaneously, the market sentiment analyzing unit determines trends and properties of the sentiments based on the collected and sorted data. Preferably, the second module 42 is capable of aggregating the main noting points from the analyzed information.

Campaign controlling step S24, in which the third module 43 receives the respective values from the second module 42, and compares them with predetermined conditions or objects to be achieved. Also in this step, based on the comparison between the collected market sentiment indexes with the pre-set objects, the third module 43 can designate actions corresponding to the actions determined in the step S21.

The storing step S25, the information about action designation, the detail information, the advertising campaign results, the collected information, etc., are stored in the system in order to monitor and re-use in next times. Wherein, the campaigns can be stored basing on the performing dates, fields, consumer objects, kinds of brand or good, etc. Preferably, the campaigns are stored basing on the order of campaign performing time.

In accordance with a preferred embodiment, the second module 42 operates periodically to evaluate the targets about market sentiments based on the information sources, pre-set conditions, thereby provides the users with the information of trends of the market sentiment indexes over time. Therefrom, through the fourth module 44, the users can initiate a new condition or a new command or a new request to aggregate information, depending on a particular request, simultaneously orient the operation of the second module 42. Through the entire operation period, the fourth module 44 can communicate with the use personal computers 2 and the information sources via the internet network.

In accordance with the preferred embodiment, via the internet network, user computers 2 can access websites stored in the operating computer 5. Wherein, the operating computer 5 manages an operating network that is one or more central servers operated concurrently by an operator of the central managing unit.

In accordance with another preferred embodiment of the invention, the steps in the advertisement managing process can be performed on various servers or computers.

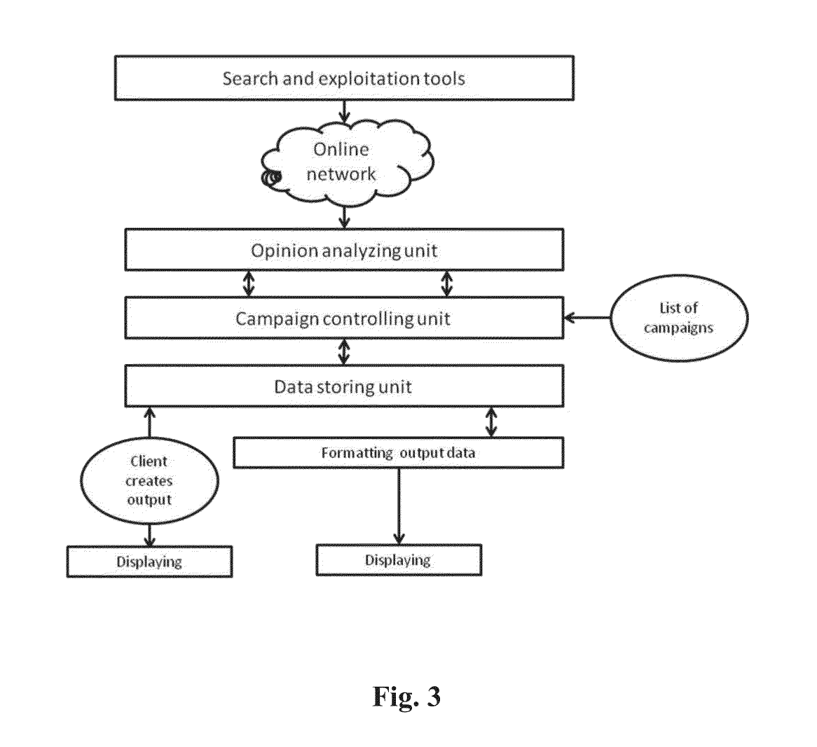

With reference to FIG. 3, that is a flow chart illustrating the flows of information, data in the operation of the online advertising managing system and the method according to the present invention. Through the overall information collecting step S22, the first module 41 is connected to predetermined information sources in the condition setting step S21.

The second module 42 analyzes the raw information collected by the first module 41 and divides this information into two big groups that are a group of mention about “information content” or a group of mention by “user”.

Wherein, the group of mention about “information content” can divide into subgroups pursuant to one or more various criteria selected from a group consisting of information forms, particularly social networking sites, online forums, electronic newspapers, etc.; information categories, particularly world, social, life, economy, entertainment, law, etc.; the object of the information, particularly female, worker, school age, etc.; or geographic area of the information sources, particularly domestic electronic newspapers, foreign electronic newspapers, province newspapers, government newspapers, etc. or the combination thereof. If the collected information indicates that the identifying of the brand is positive, then the effect of the brand will be increased, the brand is identified positively on the information channel, particularly news, blog, social networking site, etc. In contrast, if the analysis indicates that the brand is identified negatively, then the effect of the brand will be decreased. The aggregate of the market sentiments about a brand or a good, including both positiveness and negativeness, the loving level is high or low depending on number of identification or mention to the brand or good is positive or negative.

The group of mention by “user” can be divided into a plurality of subgroups based on the criteria selected from a group consisting of ages, particularly under 20, 21-35, 35-50, etc.; sex—male or female; occupation, particularly office workers, businessmans, students, etc.; income; hobbies; living place or the combination thereof. The market sentiments in each subgroup are determined to be positive or negative depending on raised opinions. The total market sentiment value of the brand or good is high or low depending on number of identification or mention to brand or good is positive or negative in each subgroup.

In the operation process, the second module 42 can determine a value and a trend of the market sentiment indexes in each sorted information group. Then, the second module 42 can designate a value for the market sentiment index and send it to the third module 43 to compare with predetermined values set in the condition setting step S21. If the value of the market sentiment index satisfies the set condition, then a controlling action with a corresponding advertising campaign is performed.

According to another aspect of the invention, when the system user starts a search command or initiates a command, the fourth module 44 will send the newly initiated command to the database stored in the system at the fifth module 45 in order to quickly search results relating to the newly initiated command. In a case if there have not yet search or analysis results relating to the newly initiated command, the first module 41 and the second module 42 will operate to search and analyze market sentiment indexes from the predetermined information sources.

In addition, the fourth module 44 can format the data to display the search or analysis results in a particular and detail manner.

In accordance with a preferred embodiment, when using the online advertising campaign managing system according to the invention, the user can access the operating computer 5 through a computer interface operated by the system 4. At this interface, the user can initiate, modify, or delete one or more commands. Preferably, the interface allows the user to create a new command by clicking “new command” in order to move to another interface that allows inputting data.

In this specification, “consumer” is referred to as client, and a person who comments on or writes about products, brands to be advertised; “user” is referred to as a person using the system of the invention to manage the advertising campaigns (can be a person of advertising business or company); “operator” is referred to as a person being responsible to operate, maintain the operation of the system of the invention.

### Examples of the Invention

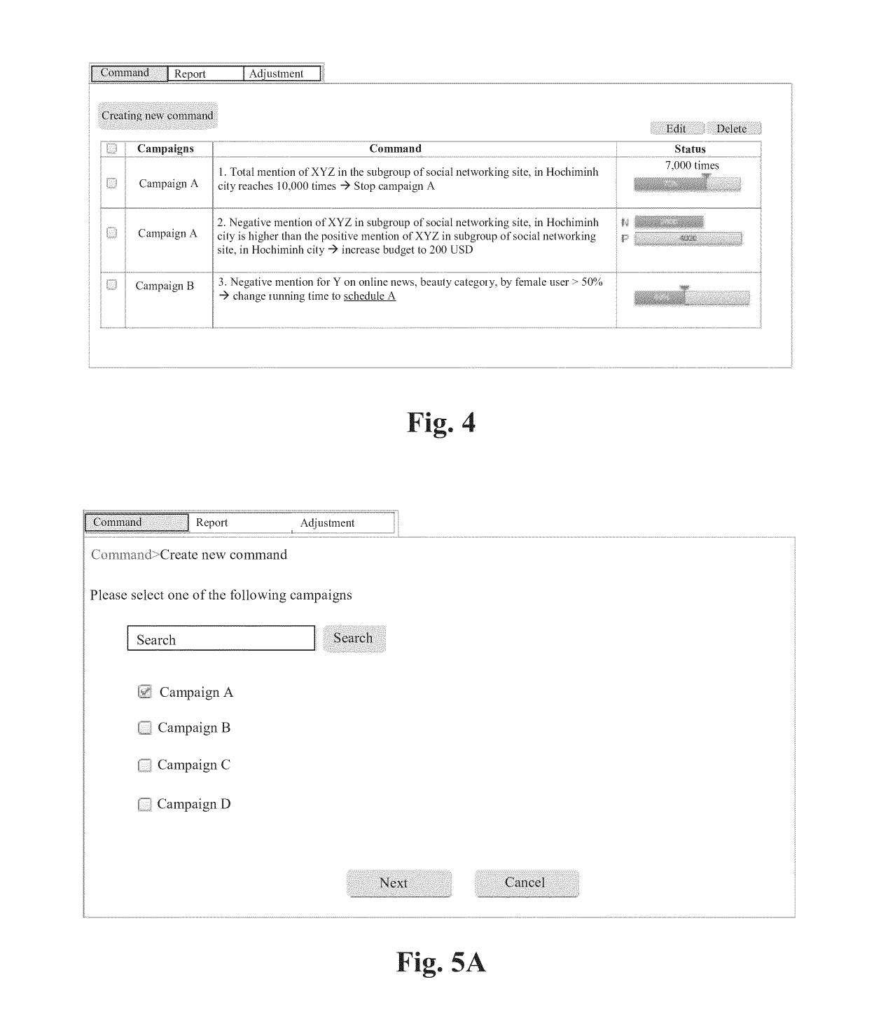

With reference to FIG. 4 that illustrates an example for carrying out a method using the system in accordance with an embodiment of the invention, in which, with the support of the fourth module 44, the user can build advertising campaigns with the various pre-set conditions. Specifically, in this example, the advertising campaign A for brand XYZ, the initially set condition is that the campaign will be stopped automatically if the number of mention for this brand in the social networking site subgroup, in Hochiminh city (in the information content group) reaches 10,000. At the same time, if the number of negative mention for the brand XYZ is higher than number of positive mention in the same subgroup, then the budget of the advertising campaign is added 200 USD. Meanwhile, an advertising campaign B with the conditions that if the negative mention for a brand YMT in the beauty category of the female subgroup exceeds 50%, the advertising campaign will be moved to another schedule. More specifically, if, at the present, the campaign is running on mornings in a week, the campaign may be moved to a schedule in which it is running on evenings in a week, because at the evenings, female have more time to access the internet, thereby bringing a better effect for the campaign.

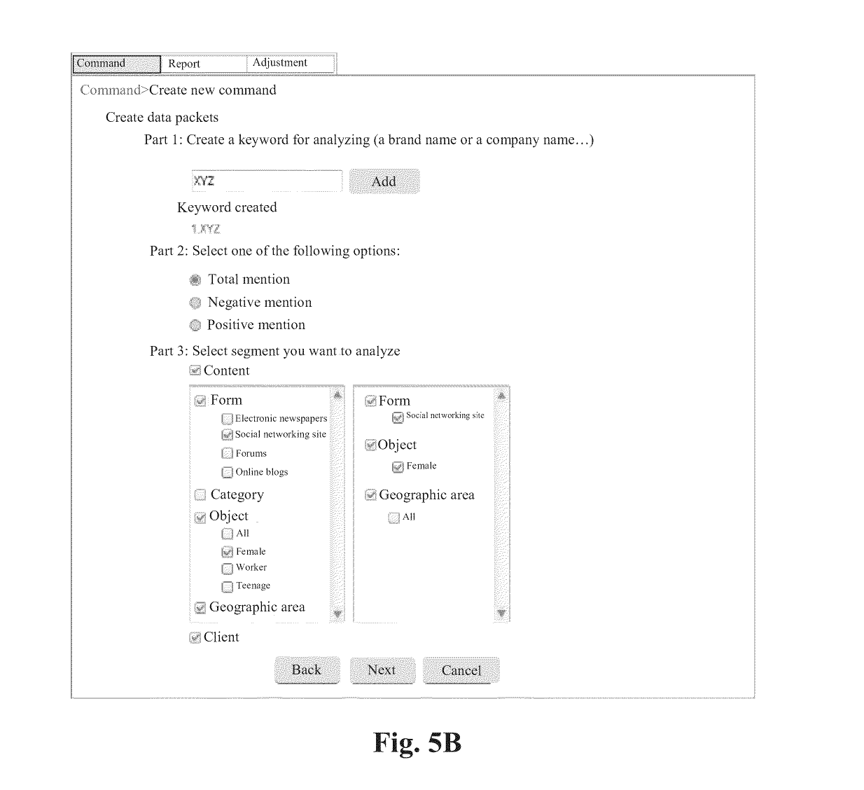

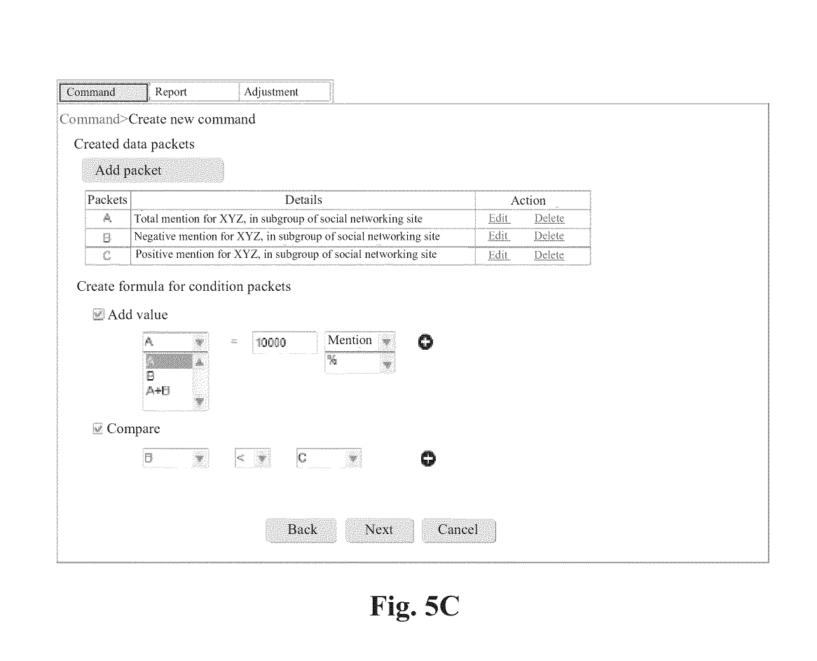

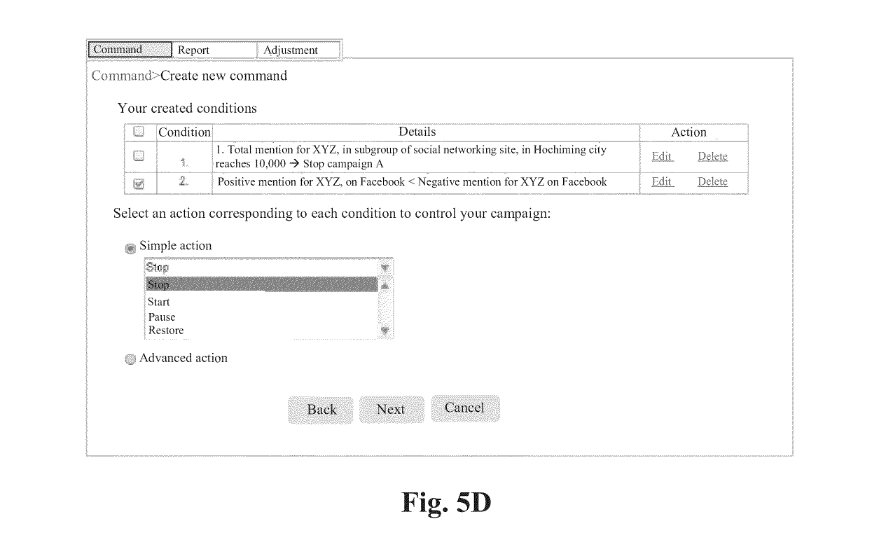

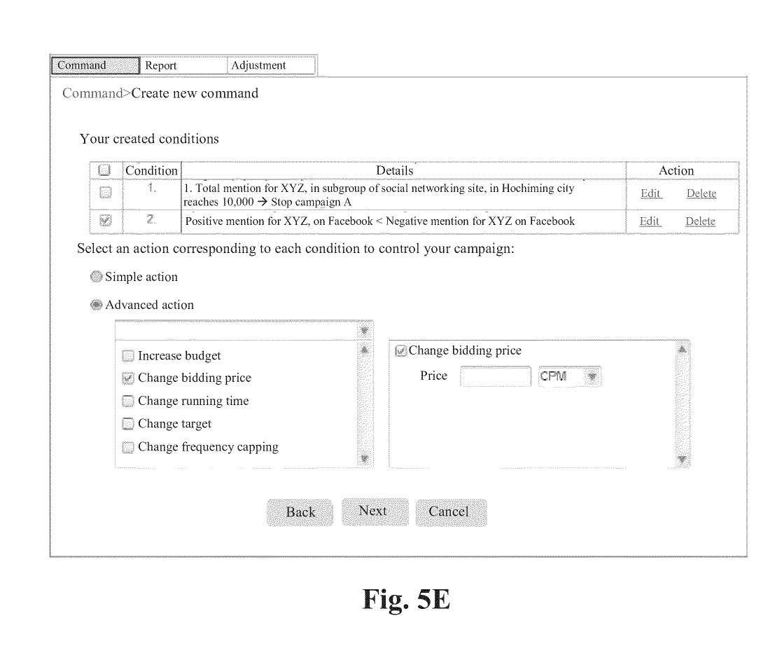

With reference to FIG. 5A-E, in which the user can set details for campaigns, different conditions for each campaign. In particular, in FIG. 5A, the user selects the predetermined campaigns. FIG. 5B, the user selects or enters interesting keywords or goods in the advertising campaign, a trend that the keywords are mentioned (positive, negative or both), selects the subgroups of the interesting information content (category, form, object, etc.) or the subgroups to which the user directs (age, sex, occupation, etc.). FIG. 5C, the user selects, set values or conditions to be achieved in the advertising campaign so that from those, the analysis results obtained from the second module 42 will be compared to identify whether or not the campaign's object has been achieved. FIG. 5D illustrate actions that the user can select to control the advertising campaign, particularly the user can initiate, pause, restart, stop or continue the campaign, additionally the user can also select more complex actions such as increase of the campaign budget, increase of running time of campaign, change of the object to be achieved, etc. (see FIG. 5E).

It should be understood that, the detailed description, examples described above, with reference to the accompanying drawings are intended to illustrate the invention only, but do not limit the scope of the invention. From the detailed description and the drawings, persons having ordinary skill in the art can make modifications, variants, these changes do not depart from the spirit and scope of the invention, as defined in the appended claims.

1. A system for managing online advertising comprising:
user personal computers connected to information sources and the remaining parts of the system;
information sources about market sentiment;
a central managing unit that includes a first module serving as an information collecting unit; a second module serving as a market sentiment analyzing unit; a third module for controlling the advertising campaign; a fourth module serving as a displaying unit of the system; a fifth module for storing information; and
a central server connected to the said personal computers and the said central managing unit.

2. The system according to claim 1, wherein the user personal computers, the information sources, the central managing unit and the central server are connected to each other via an internet network.

3. The system according to claim 2, wherein the information sources are selected from a group consisting of online electronic newspapers, online blogs, online forums and online social networking sites or combination thereof.

4. A method for managing online advertising using a system for managing online advertising, the system comprises:
user personal computers connected to information sources and the remaining parts of the system,
information sources about market sentiment,
a central managing unit that includes a first module serving as an information collecting unit, a second module serving as a market sentiment analyzing unit, a third module for controlling the advertising campaign, a fourth module serving as a displaying unit of the system, a fifth module for storing information, and
a central server connected to the said personal computers and the said central managing unit,
wherein the user personal computers, the information sources, the central managing unit and the central server are connected to each other via an internet network,
wherein the method comprises steps of:
setting keywords about brands or goods, conditions, requests for advertising campaigns with the support of the fourth module and the third module of the system;
exploiting information, the first module collects information with the conditions determined in the previous step;
analyzing a market sentiment, the second module sorts the information collected from the previous step into groups, subgroups and analyzes the market sentiment in order to determine trends and levels of the sentiment from the collected and sorted data;
controlling the advertising campaign, the third module receives the analyzed results from the second module, compares them with predetermined conditions and designates actions corresponding to the set conditions in the first step;
storing the collected information, the designation of the performing actions, the results of the advertising campaigns in the system in order to monitor and re-use in next times.

5. The method according to claim 4, wherein information from different sources collected by the first module is pre-processed by a technique selected from a group consisting of language filter, text synchronous coding, web main content identifying or combination thereof.

6. The method according to claim 5, wherein, in order to analyze the market sentiment, the second module applies nature language processing techniques such as word analyzing, text section marking, exist name identifying for detection, syntax analyzing, discussion property identifying, opinion collecting or combination thereof.

7. The method according to claim 6, wherein a raw information collected by the first module is divided into two big groups based on information content and consumer groups.

8. The method according to claim 7, wherein the consumer is divided into groups based on sex, age, occupation.

9. The method according to claim 8, wherein the first module periodically collects the information in a time period of 5 to 10 minutes.

10. The method according to claim 9, wherein the second module periodically operates based on information sources, predetermined conditions in order to provide the users with the information about trends, client's opinions over time.

11. The method according to claim 10, wherein the users and the operator is capable of accessing the system by a computer interface via the internet network.

12. The method according to claim 11, wherein at a web interface, the user is capable of initiating, modifying or deleting one or more commands.

13. The method according to claim 12, wherein when the users create a new command, the method moves to another interface to allow inputting data.

14. The method according to claim 13, wherein the steps in the advertisement managing process are capable of being performed on a plurality of servers or different computers.

15. The method according to claim 14, wherein when the users of the system start a search command or initiate a command, the fourth module sends the newly initiated command to database stored in the system in the fifth module in order to quickly search results relating to the newly initiated command before the second module collects information from other information sources.

16. The method according to claim 15, wherein the fourth module formats the data to display search and analysis results in a particular and detail manner in the form of data tables, diagrams, detecting ticket.
